(19) United States
(12) Patent Application Publication
(10) Pub. No.: US 2026/0225177 A1
(43) Pub. Date: Aug. 6, 2026

(54) ADDITIVELY MANUFACTURED PARTS AND STRUCTURES WITH FINS AND METHODS OF MANUFACTURING THE SAME

(71) Applicant: Blue Origin Manufacturing, LLC, Huntsville, AL (US)

(72) Inventors: Kristofer James Heitmeyer, Bonney Lake, WA (US); Andrew Richard Winnie, Puyallup, WA (US); Weidong Song, Woodinville, WA (US); Amos Dylan Dudley, Auburn, WA (US); W. Douglas Hartley, II, Seattle, WA (US)

(21) Appl. No.: 19/046,426

(22) Filed: Feb. 5, 2025

(51) Int. Cl. B23K 20/12; B23K 101/14; B33Y 10/00; B33Y 80/00; F28F 1/02; F28F 1/20

(52) U.S. Cl. CPC B23K 20/1215; B23K 20/129; F28F 1/022; F28F 1/20; B23K 2101/14; B33Y 10/00; B33Y 80/00; F28F 2275/062

(57) ABSTRACT

A method of additively manufacturing a part having fins is provided. In one aspect, the method includes positioning a first spacer between a first fin and a second fin, each fin having a first side and a second side, the first spacer positioned between the first side of the first fin and the second side of the second fin. The method also includes depositing at least one layer of material to join the first fin and the second fin. The method also includes removing the first spacer from between the first fin and the second fin.

### BACKGROUND

### Field

The technology relates generally to the use of additive manufacturing, for example friction stir additive manufacturing (FSAM), to form parts and structures having fins and/or integrated passages.

### Description of the Related Art

The formation of parts and structures having fins and/or integrated passages can be very costly, labor intensive, and prone to quality issues. The large number of manufacturing steps (for example, extensive amounts of welding and joining) needed can lead to these and other issues. It is therefore desirable to have efficient manufacturing processes with limited steps to form parts and structures with fins and/or integrated passages.

### SUMMARY

The embodiments disclosed herein each have several aspects no single one of which is solely responsible for the present disclosure's desirable attributes. Without limiting the scope of the present disclosure, its more prominent features will now be briefly discussed. After considering this discussion, and particularly after reading the section entitled “Detailed Description” one will understand how the features of the embodiments described herein provide advantages over existing additively manufactured parts and structures having fins and/or integrated passages and related methods.

In one aspect, a method of additively manufacturing a part having fins includes positioning a first spacer between a first fin and a second fin, each fin having a first side and a second side, the first spacer positioned between the first side of the first fin and the second side of the second fin. The method also includes depositing at least one layer of material to join the first fin and the second fin. The method also includes removing the first spacer from between the first fin and the second fin.

In some embodiments, the part is a heat exchanger. In some embodiments, the method includes positioning a second spacer between the first side of the first fin and the second side of the second fin, wherein the second spacer abuts a surface of the first spacer. In some embodiments, depositing the at least one layer of material joins the second spacer to the first fin and the second fin. In some embodiments, the second spacer and at least one of the first fin and the second fin include the same material. In some embodiments, the first spacer includes a material different than a material of the first fin and a material of the second fin. In some embodiments, the method includes drilling a plurality of passages in the at least one layer of material. In some embodiments, the method includes machining the at least one layer of material. In some embodiments, a length of the first spacer is less than a length of the first fin and a length of the second fin.

In another aspect, a heat exchanger includes a plurality of fins and a plurality of layers of deposited material. Each fin has a first end and a second end. Adjacent fins of the plurality of fins are spaced a distance apart. The distance apart is defined at least in part by at least one spacer positioned between adjacent fins during a manufacturing process. The plurality of layers of deposited material join the first ends of the plurality of fins.

In some embodiments, the heat exchanger includes a plurality of passages drilled in one or more of the plurality of layers. In some embodiments, the heat exchanger includes a plurality of spacers. Each spacer positioned between adjacent fins and joined with at least one layer of the plurality of layers of deposited material. In some embodiments, the heat exchanger includes a plurality of passages machined in one or more of the plurality of layers.

In another aspect, a structure produced by an additive manufacturing process includes positioning a first spacer between a first fin and a second fin, a material of the first spacer being different than a material of the first fin and the second fin. The process also includes depositing at least one layer of material to join the first fin and the second fin. The process also includes removing the first spacer from between the first fin and the second fin. The process also includes machining a portion of the structure.

In some embodiments, the structure is a heat exchanger. In some embodiments, machining the portion of the structure includes drilling passages through the at least one layer of material. In some embodiments, machining the portion of the structure includes machining a surface of the at least one layer. In some embodiments, the process includes positioning a second spacer between the first fin and the second fin, wherein the second spacer abuts a surface of the first spacer. In some embodiments, depositing the at least one layer of material joins the second spacer to the first fin and the second fin. In some embodiments, the second spacer and at least one of the first fin and the second fin include the same material.

In another aspect, a method of additive manufacturing a part includes forming at least a portion of a base part by moving an additive manufacturing device configured to deposit a filler material in a predetermined formation. The method also includes machining a surface of the part to form a plurality of grooves in the surface of the part. The method also includes placing a cap into each of the plurality of grooves. The method also includes depositing additional filler material configured to secure the caps within the plurality of grooves.

In some embodiments, the method includes machining the additional filler material to a predetermined shape. In some embodiments, each groove includes a rectangular region and a tapered region. The rectangular region configured to receive the cap and the tapered region configured to receive at least a region of the additional filler material. In some embodiments, each cap includes a U-shape cross section. In some embodiments, a material of each cap is different than a material of the filler material. In some embodiments, the part is a heat exchanger or a nozzle of a rocket engine.

In another aspect, a structure including integrated passages produced by an additive manufacturing process includes forming at least a portion of a base part by moving an additive manufacturing device to deposit layers of material in a predetermined formation. The process also includes machining a plurality of grooves into a surface of the initial part. The process also includes placing a cap into each of the plurality of grooves. The process also includes depositing an additional layer of material to secure the caps within the plurality of grooves. The process also includes machining the additional layer of material over the caps or at least one layer deposited over the additional filler to a predetermined shape.

In some embodiments, each groove includes a rectangular region and a tapered region. The rectangular region configured to receive the cap and the tapered region configured to receive the additional layer of material. In some embodiments, each cap includes a U-shape cross section. In some embodiments, each grooves includes a first region having a base wall and a second region having sidewalls tapered at an angle relative to a line perpendicular to the base wall of the first region. In some embodiments, each groove has a first region and a second region. The second region have at least one width that is greater than a width of the first region. In some embodiments, each cap includes a sidewall configured to contact a sidewall of the groove into which the cap is placed. In some embodiments, the structure is a heat exchanger or a nozzle of a rocket engine.

In another aspect, a structure having integrated passages includes a base part, a plurality of passages formed in the base part, and an additional layer of material. The base part is formed by depositing layers of material in a predetermined formation and including a plurality of grooves machined in a surface of the base part. Each passage is defined in part by a surface of a groove of the plurality of grooves and a cap at least partially positioned in the groove. The additional layer of material secures the cap in place.

In some embodiments, the groove includes a first region configured to receive the cap and a second region configured to receive at least a portion of the additional layer of material. In some embodiments, the additional layer of material is machined into a smooth surface. In some embodiments, the cap has a U-shape cross section. In some embodiments, the groove includes a rectangular region and a tapered region. The cap is at least partially received in the rectangular region. In some embodiments, each passage is defined on a first side by the surface of the groove and on three sides by walls of the cap. In some embodiments, the integrated passages have rectangular cross sections. In some embodiments, the structure is a heat exchanger or a nozzle of a rocket engine.

### BRIEF DESCRIPTION OF THE DRAWINGS

The above-mentioned aspects, as well as other features, aspects, and advantages of embodiments of the present disclosure will now be described in connection with various implementations, with reference to the accompanying drawings. Understanding that these drawings depict only several embodiments in accordance with the disclosure and are not to be considered limiting of its scope, the disclosure will be described with additional specificity and detail through use of the accompanying drawings. In the drawings, similar symbols typically identify similar components, unless context dictates otherwise. The illustrative embodiments of the present disclosure are not meant to be limiting. Other embodiments may be utilized, and other changes may be made, without departing from the spirit or scope of the subject matter presented here. In some drawings, various structures according to embodiments of the present disclosure are schematically shown. However, the drawings are not necessarily drawn to scale, and some features may be enlarged while some features may be omitted for the sake of clarity. The relative dimensions and proportions as shown are not intended to limit the present disclosure. It will be readily understood that the aspects of the present disclosure, as generally described herein, and illustrated in the figures, can be arranged, substituted, combined, and designed in a wide variety of different configurations, all of which are explicitly contemplated and make part of the present disclosure.

FIG. 1 is a flow chart representing an example method of manufacturing a part having fins according to an embodiment of the present disclosure.

FIG. 2 is a schematic front view of an assembly of fins, tooling spacers, and built-in spacers according to an embodiment of the present disclosure.

FIG. 3 is a schematic perspective view of the assembly of FIG. 2 according to an embodiment of the present disclosure.

FIG. 4 is a schematic view of a FSAM device being used to deposit one or more layers of material on the assembly of FIG. 2 according to an embodiment of the present disclosure.

FIG. 5 is a schematic perspective view of the assembly of FIG. 2 with one or more layers of material deposited on a surface of the assembly according to an embodiment of the present disclosure.

FIG. 6 is a schematic front view of a part having fins, built-in spacers, and cooling channels manufactured from the assembly of FIG. 2 according to an embodiment of the present disclosure.

FIG. 7 is a flow chart representing another example method of manufacturing a part having fins according to an embodiment of the present disclosure.

FIG. 8 is a schematic front view of an assembly of fins and tooling spacers according to an embodiment of the present disclosure.

FIG. 9 is a schematic perspective view of the assembly of FIG. 8 according to an embodiment of the present disclosure.

FIG. 10 is a schematic view of a FSAM device being used to deposit one or more layers of material on the assembly of FIG. 8 according to an embodiment of the present disclosure.

FIG. 11 is a schematic perspective view of the assembly of FIG. 8 with one or more layers of material deposited on a surface of the assembly and between adjacent fins according to an embodiment of the present disclosure.

FIG. 12 is a schematic front view of a part having fins and cooling channels manufactured from the assembly of FIG. 8 according to an embodiment of the present disclosure.

FIG. 13 is a flow chart representing an example method of forming a part having integrated passages according to an embodiment of the present disclosure.

FIG. 14 is a schematic cross-section of an additive manufacturing tool depositing material on a substrate.

FIG. 15 illustrates an example near net shaped part formed using additive manufacturing according to an embodiment of the present disclosure.

FIG. 16 illustrates a portion of a part having a plurality of grooves machined into a surface of the part according to an embodiment of the present disclosure.

FIG. 17 is a cross-section of a portion of the part of FIG. 16 having a cap positioned within one of the plurality grooves according to an embodiment of the present disclosure.

FIG. 18 illustrates layers of material deposited using additive manufacturing to secure a cap within a groove of a part according to an embodiment of the present disclosure.

### DETAILED DESCRIPTION

Embodiments of the present disclosure relate to use of additive manufacturing, for example friction stir additive manufacturing (FSAM), to form parts and structures having fins and/or integrated passages or other embedded or hollow internal structures. Systems and methods according to the present disclosure can align fins relative to a base structure using spacers, then use FSAM techniques to join the aligned fins to a base structure, which can include integrated passages configured to transport a liquid. Systems and methods according to the present disclosure can also use FSAM techniques to integrate passages or other hollow internal structures into the base structure, as well as other parts and structures that do not include fins. It can be understood that two or more parts can be joined to form a structure and that a single part can be a structure. Friction stir additive manufacturing devices and methods can use a tool with a high speed rotation sleeve or spindle that generates heat to soften a filler material or feed stock material. For example, the sleeve or spindle can rotate at a speed between 200 rpm and 600 rpm. Under a high pressure applied by the rotating spindle, the softened material will flow out from the spindle and can be deposited on a part or a component, for example a substrate or workpiece. The tool can be moved repeatedly over the same area to apply additional layers of material. Alternatively, the part that the material is applied to can be moved relative to the tool. This can be used to form a part with fins, passages, or other hollow internal structures.

The use of FSAM to form parts and/or structures provides various advantages. For example, FSAM uses a low process temperature. The materials used to form the parts and structures are not melted and can be molded and joined while the material is in a softened state. FSAM also allows for better material properties. Since the materials are not melted, the materials do not experience significant precipitation reactions or phase changes. The properties of the incoming material are close to the properties of the final part. FSAM can be multifunctional. For example, FSAM can be used to build a part using different materials, such as aluminum and copper, together in a component, such as a heat exchanger. The component can benefit from advantages associated with the different materials. For example, while copper can be more effective in conducting heat than aluminum, aluminum can have better structural efficiency, such that advantageous thermal and structural benefits can be integrated into the same component. In addition, FSAM is a solid-state process uniquely suited to embed objects, for example channels, passages, and sensors, into solid parts by depositing a softened filler material over the objects.

The parts, structures, systems, and methods described herein can use FSAM to build near net shape structures and parts having fins and/or integrated or embedded passages or other hollow internal structures. For example, embodiments of the present disclosure can integrate or embed passages, such as cooling channels, in various structures, including but not limited to nozzles for rocket engines, heat exchangers, actively-cooled structures, and propellant tanks, as these structures are being formed.

In a first FSAM process, FSAM can be used to form a near net shape part or structure. The near net shape structure or part can be a base structure, base part, or initial part. In a first machining process, a first surface or initial outer surface of the base structure can be machined to include a plurality of grooves or channels. Caps can be inserted into the grooves or channels to define a passage. The passage can be configured to transport a liquid, such as a coolant. In a second FSAM process, FSAM can then be used to seal or secure the caps within the base structure. The sealing of the caps within the base structure can provide protection to the caps. This can prevent structural and/or heat-related damage to the caps. In a second machining process, a second surface, for example, a new outer surface of the base structure formed by the material that overlies the caps, can be machined to form a smooth outer surface.

An FSAM process can be used to form a part of a structure having fins. An assembly of fins, tooling spacers, and/or built-in spacers can be assembled. An FSAM device can be used to deposit material to join ends of adjacent fins and/or to join fins and built-in spacers positioned between adjacent fins. After deposition of material to join the ends of adjacent fins and/or to join the fins and built-in spacers positioned between adjacent fins, the tooling spacers can be removed. The joined adjacent fins and/or joined fins and built-in spacers can then be machined to form a final part, including but not limited to a heat exchanger.

Embodiments of FSAM processes according to the present disclosure can reduce manufacturing costs, reduce manufacturing steps and time, simplify quality control, and enhance structural reliability and integrity of structures formed with fins and/or integrated passages. The parts and structures according to the present disclosure can be manufactured using methods and processes resulting in high efficiency, quality, durability, and reliability. The embodiments according to the present disclosure also allow for the manufacture of parts using multiple materials, for example, the production of heat exchangers typically utilizes multiple materials such as copper and aluminum. In contrast, typical single material manufacturing processes greatly limit the performance of the manufactured part.

Further, embodiments of the present disclosure may be used to integrate prefabricated, highly dimensional, accurate, and effective fins and cooling channels together for achieving low manufacturing cost and high system performance and reliability. As a solid-state process, the methods and systems according to embodiments of the present disclosure can effectively combine different materials such as copper, aluminum, stainless steel, among many other materials, in a single build. The FSAM processes according to embodiments of the present disclosure can solve challenges faced by both traditional and laser powder fed fusion (LPBF) manufacturing technologies.

### Example Embodiments of Additively Manufactured Parts and Structures Having Fins

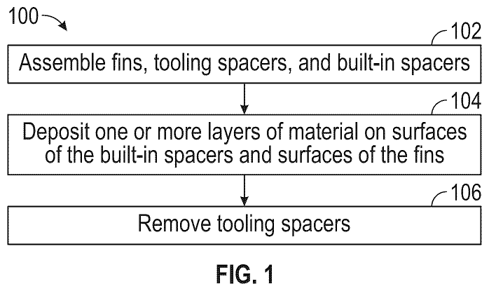

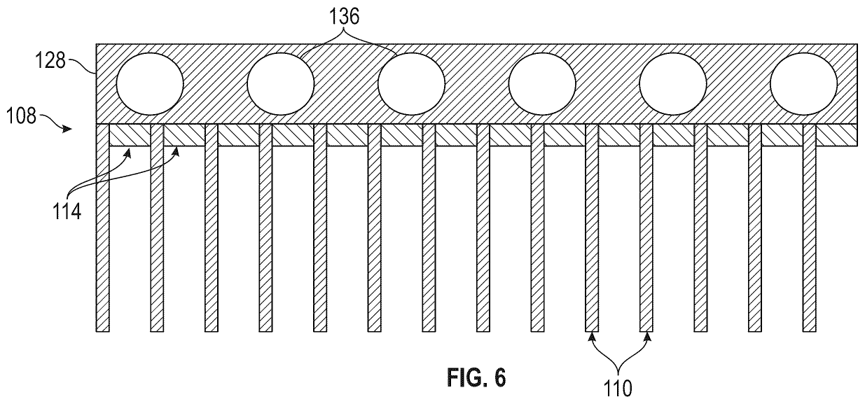

Various example embodiments of additively manufactured parts having fins according to the present disclosure will now be described with respect to the figures. FIG. 1 is a flow chart representing an example method 100 of forming a part 108 (for example, as shown in FIG. 6) according to an embodiment of the present disclosure. Embodiments of the method 100 may include any of the features of the methods discussed above or below and should not be limited to the particular embodiments described. For example, features of one embodiment may be combined with features of another embodiment. The particular modifications shown in FIGS. 1-6 will now be discussed in detail and features not discussed will be understood to be similar, or identical, to those discussed elsewhere herein. Some or all of the modifications discussed with respect to FIGS. 1-6 may be incorporated into the other embodiments described herein.

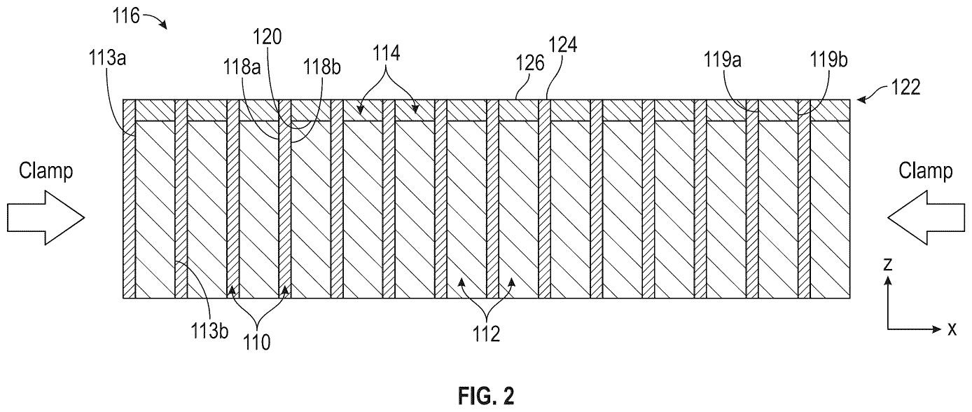

FIGS. 2-6 illustrate various example stages of the part 108 being formed according to an embodiment of the present disclosure. While the illustrated part 108 is a heat exchanger, the method 100 according to embodiments of the present disclosure can be implemented to manufacture any type of part or structure having fins or similar features.

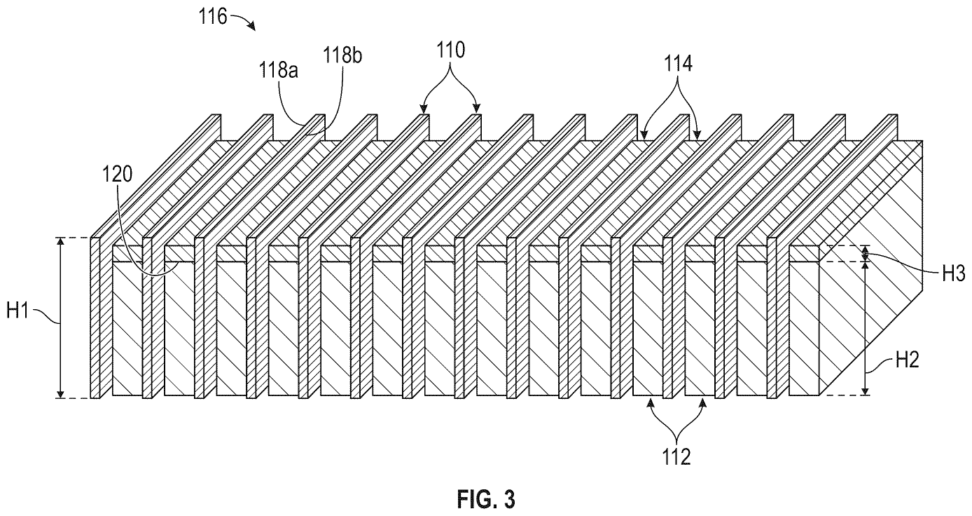

With reference to block 102 of FIG. 1 and corresponding FIGS. 2 and 3, a plurality of fins 110, one or more tooling spacers 112, and one or more built-in spacers 114 can be assembled into an assembly 116. The tooling spacers 112 may be configured to be removed from an intermediate part used in the formation of a final part. The built-in spacers 114 may remain a component of the final part (for example, a heat exchanger). The use of built-in spacers 114 may be advantageous as the built-in spacers 114 can prevent or limit added material from contacting the tooling spacers 112 during the manufacturing process. Adjacent fins 110 can be separated by a tooling spacer 112 and/or a built-in spacer 114. The fins 110 can alternate with pairs of a tooling spacer 112 and a built-in spacer 114 in the x-direction.

In one embodiment, moving from the negative x-direction to the positive x-direction, a pair of spacers 112, 114 can start the arrangement of fins 110 and spacers 112, 114 and a pair of spacers 112, 114 can end the arrangement of fins 110 and spacers 112, 114. In another embodiment, moving from the negative x-direction to the positive x-direction, a fin 110 can start the arrangement of fins 110 and spacers 112, 114, and a fin 110 can end the arrangement of fins 110 and spacers 112, 114. In another embodiment, moving from the negative x-direction to the positive x-direction, a fin 110 can start the arrangement of fins 110 and spacers 112, 114, and a pair of spacers 112, 114 can end the arrangement of fins 110 and spacers 112, 114, as shown in FIG. 2. In another embodiment, moving from the negative x-direction to the positive x-direction, a pair of spacers 112, 114 can start the arrangement of fins 110 and spacers 112, 114, and a fin 110 can end the arrangement of fins 110 and spacers 112, 114.

In some embodiments, clamps can be used to secure the fins 110, tooling spacers 112, and built-in spacers 114 in a linear arrangement. The clamps can secure the assembly 116 in a linear arrangement along the x-axis, along the y-axis, and/or along the z-axis. The clamps can apply a force in the x-direction, y-direction, and/or z-direction. The clamps can prevent or limit movement of the fins 110, tooling spacers 112, and built-in spacers 114 as the final part is being manufactured. In embodiments having pairs of spacers 112, 114 on either end of the assembly 116, the clamps can apply a force in the x-direction on one or both of the spacers 112, 114.

Each fin 110 may have a first side 118a and a second side 118b opposite the first side 118a. A tooling spacer 112 may be positioned between the first side 118a of a first fin 110 and the second side 118b of a second, adjacent fin 110. A first side 113a of the tooling spacer 112 may contact the second side 118b of the second fin 110. A second side 113b of the tooling spacer 112 may contact the first side 118a of the first fin 110. A built-in spacer 114 may be positioned between the first side 118a of the first fin 110 and the second side 118b of the second, adjacent fin 110, and abut a surface 120 of the tooling spacer 112 positioned between the same adjacent fins 110. A first side 119a of the built-in spacer 114 may contact the second side 118b of the second fin 110. A second side 119b of the built-in spacer 114 may contact the first side 118a of the first fin 110. A width of the tooling spacer 112 can be the same as a width of the built-in spacer 114.

The fins 110 can have a height H1 that exceeds a height H2 of the tooling spacers 112, such that a portion of each fin 110 extends beyond the surface 120 of the tooling spacer 112 in the z-direction. The built-in spacers 114 can be positioned adjacent or abutting the surface 120 of the tooling spacers 112 and between portions of adjacent fins 110 that extend beyond the surface 120 of the tooling spacers 112. The built-in spacers 114 can have a height H3. In some embodiments, the height H3 of the built-in spacer 114 combined with the height H2 of the tooling spacer 112 can equal the height H1 of the fins 110. In some embodiments, the height H3 of the built-in spacer 114 combined with the height H2 of the tooling spacer 112 can be less than the height H1 of the fins 110. In some embodiments, the height H3 of the built-in spacer 114 combined with the height H2 of the tooling spacer 112 can be greater than the height H1 of the fins 110.

The height H1 of a fin 110 can be between about 2 mm to about 100 mm, for example, about 2 mm, about 10 mm, about 20 mm, about 30 mm, about 40 mm, about 50 mm, about 60 mm, about 70 mm, about 80 mm, about 90 mm, about 100 mm, more or less, or any value in between. The thickness of a fin 110 can be between about 25 microns to about 500 microns, for example, about 25 microns, about 50 microns, about 100 microns, about 150 microns, about 200 microns, about 250 microns, about 300 microns, about 350 microns, about 400 microns, about 450 microns, about 500 microns, more or less, or any value in between. The length of a fin 110 can be between about 1 cm to about 200 cm, for example, about 1 cm, about 20 cm, about 40 cm, about 60 cm, about 80 cm, about 100 cm, about 120 cm, about 140 cm, about 160 cm, about 180 cm, about 200 cm, more or less, or any value in between. The height H3 of a built-in spacer 114 can be between about 2 mm to about 8 mm, for example, about 2 mm, about 3 mm, about 4 mm, about 5 mm, about 6 mm, about 7 mm, about 8 mm, more or less, or any value in between. The distance between adjacent fins 110 or the thickness of a tooling spacer 112 can be between 5 to 50 times the thickness of the fins 110. It will be understood that embodiments of the present disclosure are not limited to fins having lengths in the millimeter and centimeter range, and can be suitably implemented in assemblies with fins having a length of 1 meter, 2 meters, 3 meters, more or less, or any value in between. The height and thickness of the fins, the distance between adjacent fins, and the height H3 of a built-in spacer can also vary from the ranges described above in embodiments of the present disclosure.

The fins 110 and the built-in spacers 114, in the assembled form 116, can define a surface 122. The surface 122 can be a continuous planar surface. In some embodiments, the surface 122 can be a curved or non-planar surface. In embodiments where the combined height of the height H2 of the tooling 112 and the height H3 of the built-in spacer 114 does not equal the height H1 of the fins 110, the surface 122 can have peaks and valleys or recessed regions and protruding regions. Surfaces 124 of the fins 110 and surfaces 126 of the built-in spacers 114 can define the surface 122.

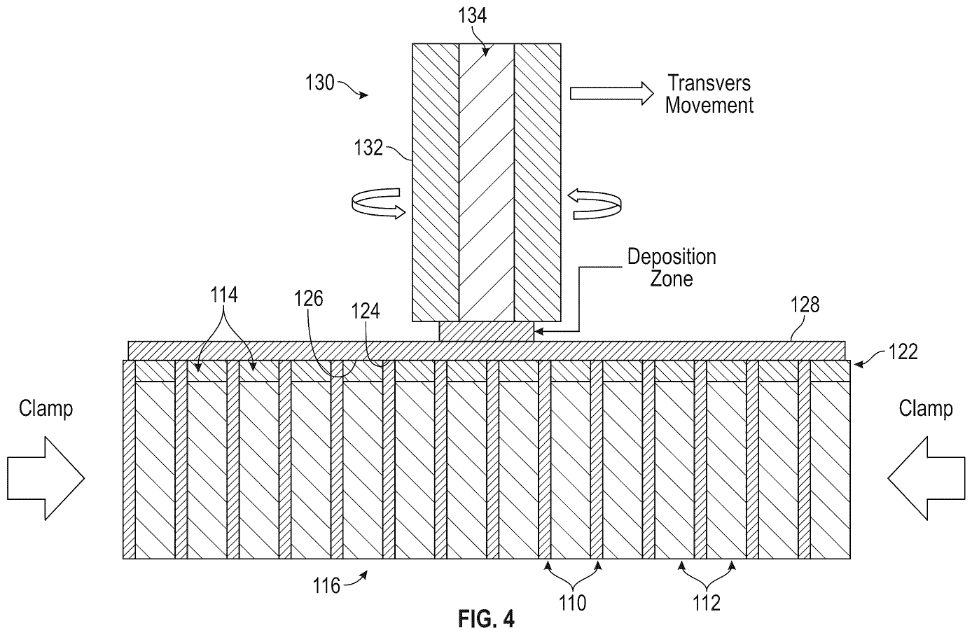

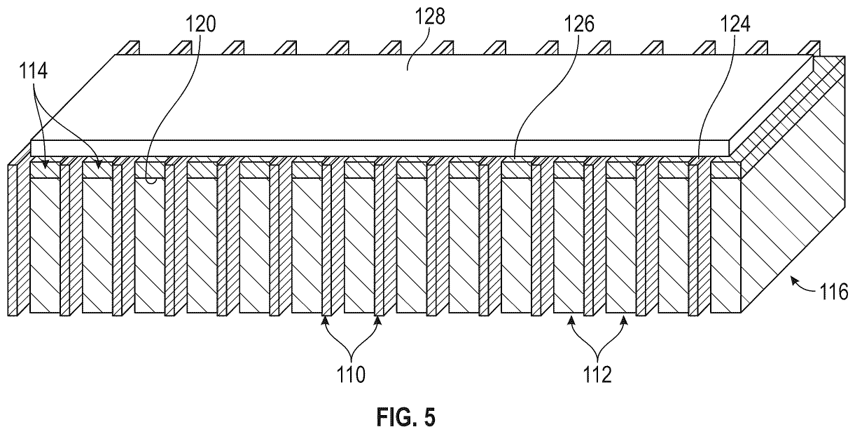

Moving to block 104 of FIG. 1 and corresponding FIGS. 4 and 5, one or more layers of material 128 can be deposited on the surface 122 defined by the surfaces 124 of the fins 110 and the surfaces 126 of the built-in spacers 114. An additive manufacturing device, for example an FSAM device 130, can be used to deposit the one or more layers of material 128. One non-limiting example of the FSAM device 130 can include a rotating shoulder 132 that plasticizes filler material as the rotating shoulder 132 rotates. The plasticized filler material can travel through a channel 134 of the rotating shoulder 132 and be deposited on the surface 122 as the FSAM device 130 is moved across the surface 122. The plasticized filler material can be deposited on the surface 126 of the built-in spacers 114 and the surfaces 124 of the fins 110. The deposition of the one or more layers 128 of the plasticized material can join the built-in spacers 114 and fins 110 together.

In embodiments where the combined height of the height H2 of the tooling spacer 112 and the height H3 of the built-in spacer 114 equals the height H1 of the fins 110, the one or more layers of material 128 can be applied on and/or contact the surfaces 126 of the built-in spacers 114 and the surfaces 124 of the fins 110. In some embodiments, the one or more layers of material 128 may be applied on and/or contact portions of the surfaces 126 of the built-in spacers 114 and portions the surfaces 124 of the fins 110. In embodiments where the combined height of the height H2 of the tooling spacer 112 and the height H3 of the built-in spacer 114 is less than the height H1 of the fins 110, for example as shown in FIG. 3, the one or more layers of material 128 can be applied on and/or contact the surfaces 126 of the built-in spacers 114, the surfaces 124 of the fins 110, and portions of the sides 118a, 118b of the fins 110. In some embodiments, the one or more layers of material 128 may be applied on and/or contact portions of the surfaces 126 of the built-in spacers 114, portions of the surfaces 124 of the fins 110, and portions of the sides 118a, 118b of the fins 110. In embodiments where the combined height of the height H2 of the tooling spacers 112 and the height H3 of the built-in spacer 114 is greater than the height H1 of the fins 110, the one or more layers of material 128 can be applied on and/or contact the surfaces 126 of the built-in spacers 114, the surfaces 124 of the fins 110, and portions of the sides 119a, 119b of the built-in spacers 114. In some embodiments, the one or more layers of material 128 may be applied on and/or contact portions of the surfaces 126 of the built-in spacers 114, portions of the surfaces 124 of the fins 110, and portions of the sides 119a, 119b of the built-in spacers 114.

Not all fins 110 need to be the same height, for example the fins 110 can vary in height. Not all tooling spacers 112 need to be the same height, for example the tooling spacers 112 can vary in height. Not all built-in spacers 114 need to be the same height, for example the built-in spacers 114 can vary in height. Not all pairs of tooling spacers 112 and built-in spacers 114 need to be the same height, for example the combined height of pairs of tooling spacers 112 and built-in spacers 114 can vary. The methods described herein can be advantageous as the use of additive manufacturing systems can account for the variance in heights and join uneven surfaces.

The fins 110 can be a metal material. The fins 110 may be the same material as the material deposited by the FSAM device 130. In some embodiments, the fins 110 can be a metal foil. In some embodiments, the fins 110 can include aluminum, copper, silver, or gold. The fins 110 can include materials having high thermal conductivity. Other materials can be suitably implemented in embodiments of the present disclosure. The tooling spacers 112 can include steel, aluminum, or ceramic. The tooling spacers 112 can include durable and low cost materials. For example, tooling spacers 112 including durable materials, such as tool steel, can advantageously be re-used during manufacture of a plurality of parts 108. Other materials can be suitably implemented in embodiments of the present disclosure. The tooling spacers 112 can be a material having non-stick properties, for example, the tooling spacers 112 may be stainless steel when the material deposited by the FSAM device 130 is aluminum, or the tool spacers 112 may be silicon carbide ceramic when the material deposited by the FSAM device 130 is copper. The built-in spacers 114 can be the same or similar material as the fins 110.

Moving to block 106 of FIG. 1 and corresponding FIG. 6, tooling spacers 112 can be removed. The tooling spacers 112 can be removed mechanically. The tooling spacers 112 may not be bonded to other components of the assembly, facilitating removal using a mechanical process. The tooling spacers 112 can be removed after the one or more layers of material 128 is applied, as the one or more layers of material 128 deposited does not contact the tooling spacers 112, for example, the built-in spacers 114 can prevent or limit the one or more layers of material 128 from contacting or abutting the tooling spacers 112. The clamps can be released to allow removal of the tooling spacers 112. The tooling spacers 112 being a nonstick material can facilitate removal of the tooling spacers 112 from between adjacent fins 110. The tooling spacers 112 can provide lateral support to the fins 110 during the manufacturing process and can prevent or reduce buckling of the fins 110.

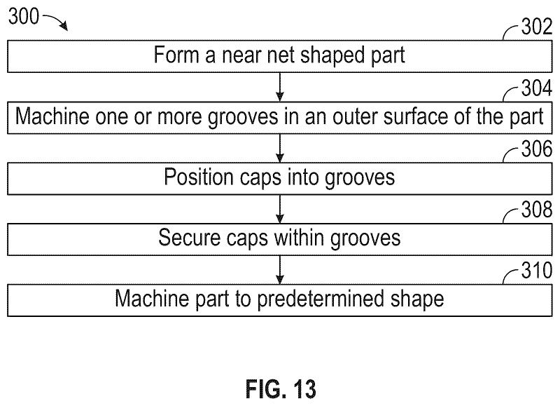

In some embodiments, the part 108 can be machined to include one or more passages 136, channels, or holes. The one or more passages 136 may have a circular, square, rectangular, or any other suitably shaped cross-section. The one or more passages 136 may define cooling channels. The cooling channels may be configured to transport a work media, such as a coolant. In non-limiting embodiments, the working media can include a liquid, a gas, and/or molten salts and metals. Many types of fluids can be suitably implemented as a work media in embodiments of the present disclosure. The one or more passages 136 can be drilled into the one or more layers of material 128 that was deposited using the FSAM device 130. The one or more passages 136 may be formed using any of the methods according to embodiments of the present disclosure, for example, the methods described with reference to FIGS. 13-18. In some embodiments, the part 108 can be machined to a predetermined shape, for example, the one or more layers of material 128 deposited using the FSAM device 130 can be machined to an intended predetermined shape or final part.

The final part may be a heat exchanger having fins. The heat exchanger may also include passages in an additively manufactured base part that connects the fins. In other embodiments, the final part may be any structure having fins and/or passages in an additively manufactured base part.

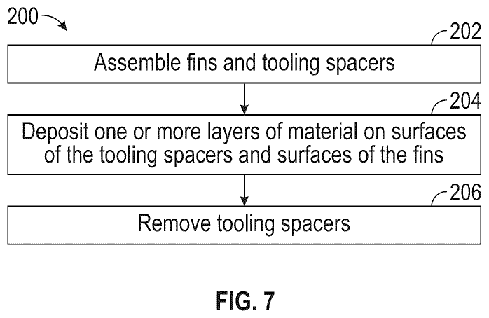

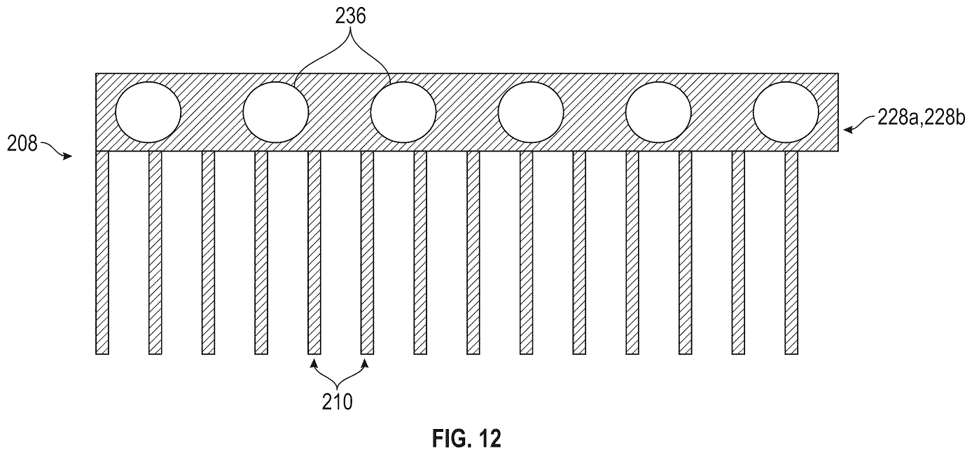

FIG. 7 is a flow chart representing an example method 200 of forming a part 208 (for example, as shown in FIG. 12) according to another embodiment of the present disclosure. Embodiments of the method 200 may include any of the features of the methods discussed above or below and should not be limited to the particular embodiments described. For example, features of one embodiment may be combined with features of another embodiment. The particular modifications shown in FIGS. 7-12 will now be discussed in detail, and features not discussed will be understood to be similar, or identical, to those discussed elsewhere herein. Some or all of the modifications discussed with respect to FIG. 7-12 may be incorporated into the other embodiments described herein.

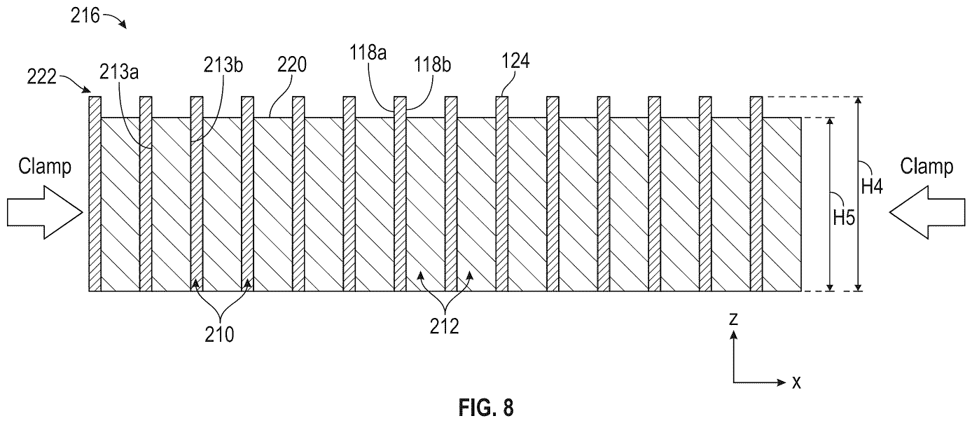

FIGS. 8-12 illustrate various example stages of the part 208 being formed according to an embodiment of the present disclosure. While the illustrated part 208 is a heat exchanger, the method 200 according to embodiments of the present disclosure can be implemented to manufacture any type of part or structure having fins or similar features.

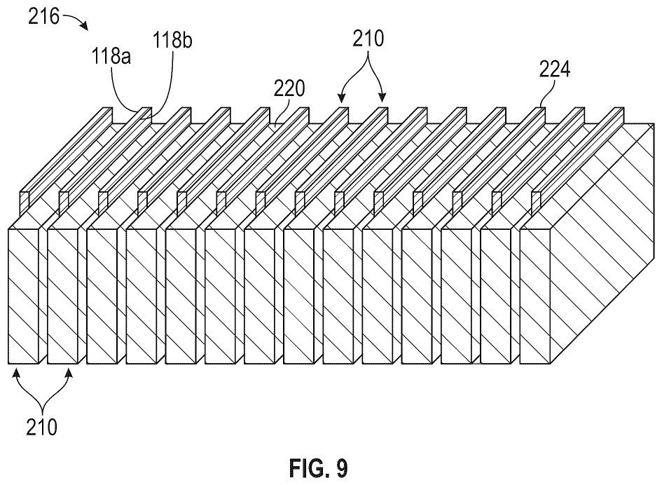

With reference to block 202 of FIG. 7 and corresponding FIGS. 8 and 9, a plurality of fins 210 and one or more tooling spacers 212 can be assembled into an assembly 216. Adjacent fins 210 can be separated by a tooling spacer 212. The tooling spacers 212 may be configured to be removed from an intermediate part used in the formation of a final part. The fins 210 can alternate with tooling spacers 212 in the x-direction.

In one embodiment, moving from the negative x-direction to the positive x-direction, a tooling spacer 212 can start the arrangement of fins 210 and tooling spacers 212 and a tooling spacer 212 can end the arrangement of fins 210 and tooling spacers 212. In another embodiment, moving from the negative x-direction to the positive x-direction, a fin 210 can start the arrangement of fins 210 and tooling spacers 212, and a fin 210 can end the arrangement of fins 210 and tooling spacers 212. In another embodiment, moving from the negative x-direction to the positive x-direction, a fin 210 can start the arrangement of fins 210 and tooling spacers 212, and tooling spacer 212 can end the arrangement of fins 210 and tooling spacers 212, as shown in FIG. 8. In another embodiment, moving from the negative x-direction to the positive x-direction, a tooling spacer 212 can start the arrangement of fins 210 and tooling spacers 212, and a fin 210 can end the arrangement of fins 210 and tooling spacers 212.

In some embodiments, clamps can be used to secure the fins 210 and tooling spacers 112 in a linear arrangement. The clamps can secure the assembly 116 in a linear arrangement along the x-axis, along the y-axis, and/or along the z-axis. The clamps can apply a force in the x-direction, y-direction, and/or z-direction. The clamps can prevent or limit movement of the fins 110 and tooling spacers 112 as the final part is being manufactured.

Each fin 210 may have a first side 218a and a second side 218b opposite the first side 218a. Each tooling spacer 212 may be positioned between the first side 218a of a first fin 210 and the second side 218b of a second fin 210. A first side 213a of the tooling spacer 212 may contact the second side 218b of the second fin 210. A second side 213b of the tooling spacer 212 may contact the first side 218a of the first fin 210.

The fins 210 can have a height H4 that exceeds a height H5 of the tooling spacers 212, such that a portion of each fin 210 extends beyond the surface 220 of the tooling spacers 212. In some embodiments, the height H4 of the fins 210 and the height H5 of the tooling spacers can be the same. In some embodiments, the height H5 of the tooling spacer 212 can be greater than the height H4 of the fins 210.

The height H4 of a fin 210 can be between about 2 mm to about 100 mm, for example, about 2 mm, about 10 mm, about 20 mm, about 30 mm, about 40 mm, about 50 mm, about 60 mm, about 70 mm, about 80 mm, about 90 mm, about 100 mm, more or less, or any value in between. The thickness of a fin 210 can be between about 25 microns to about 500 microns, for example, about 25 microns, about 50 microns, about 100 microns, about 150 microns, about 200 microns, about 250 microns, about 300 microns, about 350 microns, about 400 microns, about 450 microns, about 500 microns, more or less, or any value in between. The length of a fin 210 can be between about 1 cm to about 200 cm, for example, about 1 cm, about 20 cm, about 40 cm, about 60 cm, about 80 cm, about 100 cm, about 120 cm, about 140 cm, about 160 cm, about 180 cm, about 200 cm, more or less, or any value in between. The distance between adjacent fins 210 or the thickness of a tooling spacer 212 can be between 5 to 50 times the thickness of the fins 210. It will be understood that embodiments of the present disclosure are not limited to fins having lengths in the millimeter and centimeter range, and can be suitably implemented in assemblies with fins having a length of 1 meter, 2 meters, 3 meters, more or less, or any value in between. The height and thickness of the fins, the distance between adjacent fins, and the height H3 of a built-in spacer can also vary from the ranges described above in embodiments of the present disclosure.

The fins 210 and the tooling spacers 212, in the assembled form 216, can define a surface 222. The surface 122 can be non-planar, for example, the surface 122 can have peaks and valleys or recessed regions and protruding regions. The surface 122 can have peaks or valleys or recessed regions and protruding regions due to a height difference between the height H4 of the fins 210 and the height H5 of the tooling spacers 212. The surface 122 can have peaks or valleys or recessed regions and protruding regions due to variance in the height H4 of each fin 210 and/or variance in the height H5 of each tooling spacer 212. In some embodiments, the surface 122 can be planar, for example, when the height H4 of the fins 210 is the same as the height H5 of the tooling spacer(s) 212. Surfaces 224 of the fins 210 and surfaces 220 of the tooling spacer(s) 212 can define the surface 222.

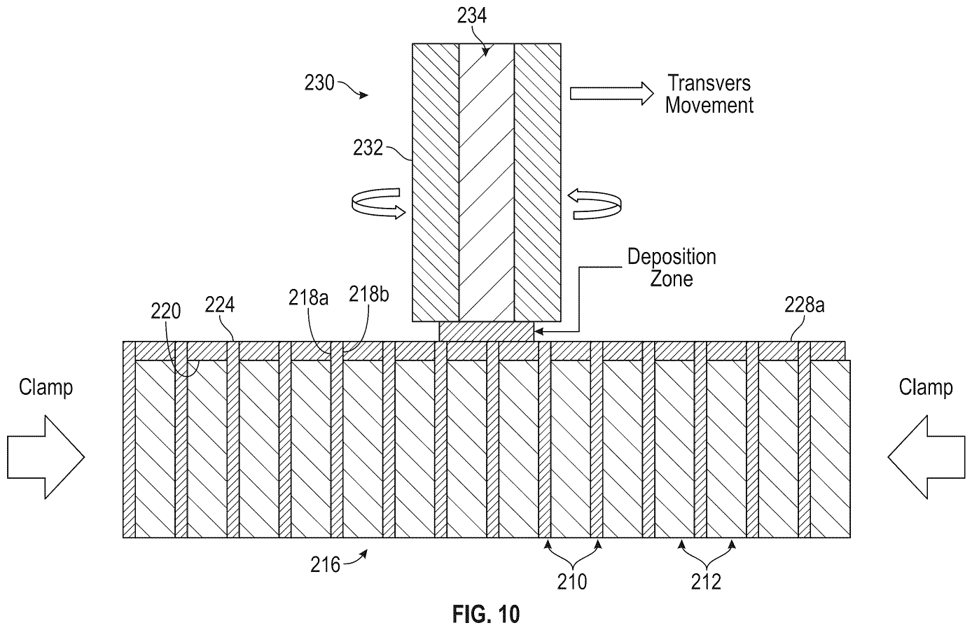

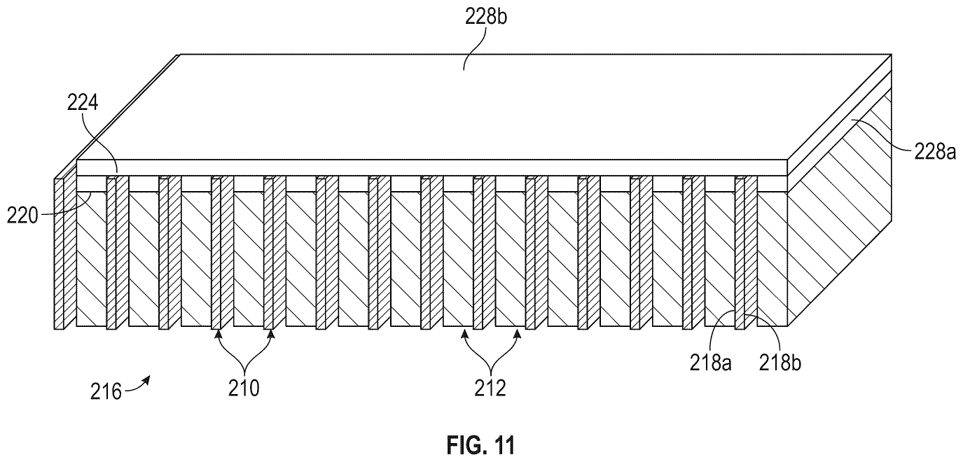

Moving to block 204 of FIG. 7 and corresponding FIGS. 10 and 11, one or more layers of material 228 can be deposited on the surface 222 defined by the surfaces 224 of the fins 210 and the surfaces 220 of the tooling spacers 212. An additive manufacturing device, for example an FSAM device 230, can be used to deposit the one or more layers of material 228. One non-limiting example of the FSAM device 230 can include a rotating shoulder 232 that plasticizes filler material as the rotating shoulder 232 rotates. The plasticized filler material can travel through a channel 234 of the rotating shoulder 232 and be deposited on the surface 222 as the FSAM device 230 is moved across the surface 222. The plasticized filler material can be deposited on the surface 220 of the tooling spacers 212 and the surfaces 224 of the fins 210. In embodiments where the height H4 of the fins exceeds the height H5 of the tooling spacers 212, one or more layers 228a of the one or more layers of material 228 can fill the valleys or recessed areas defined by surfaces 220 of the tooling spacers 212, the first side 218a of a first fin 210, and the second side 218b of a second fin 210. One or more layers 228b of the one or more layers of material 228 can be deposited on top of the one or more layers 228a and/or the surfaces 224 of the fins 210. The deposition of the one or more layers 228 of the plasticized material can join adjacent fins 210 together.

In embodiments where the height H5 of the tooling spacers 212 equal the height H4 of the fins 210, the one or more layers of material 228 can be applied on and/or contact the surfaces 220 of the tooling spacers 212 and the surfaces 224 of the fins 210. In some embodiments, the one or more layers of material 228 may be applied on and/or contact portions of the surfaces 220 of the tooling spacers 212 and portions of the surfaces 224 of the fins 210. In embodiments where the height H5 of the tooling spacers 212 is less than the height H4 of the fins 210, the one or more layers of material 228 can be applied on and/or contact the surfaces 220 of the tooling spacers 212, the surfaces 224 of the fins 210, and portions of the sides 218a, 218b of the fins 210. In some embodiments, the one or more layers of material 228 may be applied on and/or contact portions of the surfaces 220 of the tooling spacers 212, portions of the surfaces 224 of the fins 210, and portions of the sides 218a, 218b of the fins 210. In embodiments where the height H5 of the tooling spacers 212 is greater than the height H4 of the fins 210, the one or more layers of material 228 can be applied on and/or contact the surfaces 220 of the tooling spacers 214, the surfaces 224 of the fins 210, and portions of the sides 213a, 213b of the tooling spacers 212. In some embodiments, the one or more layers of material 228 may be applied on and/or contact portions of the surfaces 220 of the tooling spacers 212, portions of the surfaces 224 of the fins 210, and portions of the sides 213a, 213b of the tooling spacers 212. The one or more layers of material 228 can join ends of the adjacent fins 210.

Not all fins 210 need to be the same height, for example the fins 210 can vary in height. Not all tooling spacers 212 need to be the same height, for example the tooling spacers 212 can vary in height. The methods described herein can be advantageous as the use of additive manufacturing systems can account for the variance in heights and join uneven surfaces.

The fins 210 can be a metal material. The fins 210 may be the same material as the material deposited by the FSAM device 230. In some embodiments, the fins 210 can be a metal foil. In some embodiments, the fins 210 can include aluminum, copper, silver, or gold. The fins 210 can include materials having high thermal conductivity. Other materials can be suitably implemented in embodiments of the present disclosure. The tooling spacers 212 can include steel, aluminum, or ceramic. The tooling spacers 212 can include durable and low cost materials. For example, tooling spacers 212 including durable materials, such as tool steel, can advantageously be re-used during manufacture of a plurality of parts 208. Other materials can be suitably implemented in embodiments of the present disclosure. The tooling spacers 212 can be a nonstick material, for example, the tool spacers 212 may be stainless steel when the material deposited by the FSAM device 230 is aluminum or the tooling spacers 212 may be silicon carbide ceramic when the material deposited by the FSAM device 230 is copper.

Moving to block 206 of FIG. 7 and corresponding FIG. 12, tooling spacers 212 can be removed. The tooling spacers 212 can be mechanically removed. The clamps can be released to allow removal of the tooling spacers 212. The tooling spacers 212 being a nonstick material can allow for removal of the tooling spacers 212 from between adjacent fins 110. The use of a nonstick material can prevent the material deposited by the FSAM device 230 from adhering to the tooling spacers 212 and from joining the tooling spacers 212 to the fins 210. In some embodiments, the tooling spacers 212 include a material that is particularly resistant to bonding to material deposited by the FSAM device 230. The tooling spacers 212 can provide lateral support to the fins 210 during the manufacturing process and can prevent or reduce buckling of the fins 210.

In some embodiments, the part 208 can be machined to include one or more passages 236, channels, or holes. The one or more passages 236 may have a circular, square, rectangular, or any other suitable shaped cross-section. The one or more passages 236 may define cooling channels. The one or more passages 236 can be drilled in the one or more layers of material 228 that was deposited using the FSAM device 230. The one or more passages 236 may be formed using any of the methods according to embodiments of the present disclosure, for example, the methods described with reference to FIGS. 13-18. In some embodiments, the part 208 can be machined to a predetermined shape, for example, the one or more layers of material 228 deposited using the FSAM device 230 can be machined to an intended predetermined shape. In some non-limiting embodiments, manufacture of the part 208 requires fewer materials and labor than manufacture of the part 108.

The final part may be a heat exchanger having fins. The heat exchanger may also include passages in an additively manufactured base part that connects the fins. In other embodiments, the final part may be any structure having fins and/or passages in an additively manufactured base part.

### Example Embodiments of Additively Manufactured Parts and Structures with Integrated Passages or Channels

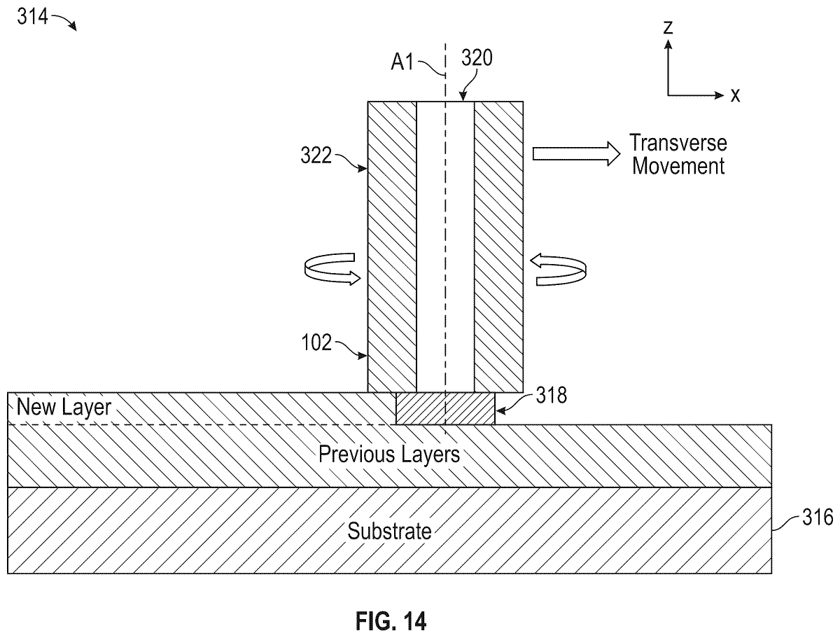

Various example embodiments of additively manufactured parts and structures with integrated passages or channels according to the present disclosure will now be described with respect to the figures. FIG. 13 is a flow chart representing an example method 300 of forming a part having integrated passages or channels according to an embodiment of the present disclosure. FIGS. 14-17 illustrate various example stages of the part being formed according to an embodiment of the present disclosure. The methods described herein can be incorporated with the methods described above with reference to FIGS. 1-12, for example, the passages formed by grooves and caps can be formed in the one or more layers of material 128, 228 described above.

FIG. 14 is a schematic view of an additive manufacturing tool 314 configured to form a part or structure according to an embodiment of the present disclosure. The additive manufacturing tool 314 can be used to deposit a filler material to a deposition zone 318. Example filler materials include but are not limited to copper, titanium, steels, and nickel alloys. The filler material can be a single type of material or a mixture of materials. The filler material can flow through a channel 320 of a spindle 322. The spindle 322 can be configured to rotate about a central axis A1 extending through the center of the spindle 322. The rotation of the spindle 322 can generate heat to soften the filler material, which can allow the filler material to flow through the channel 320 and to the deposition zone 318.

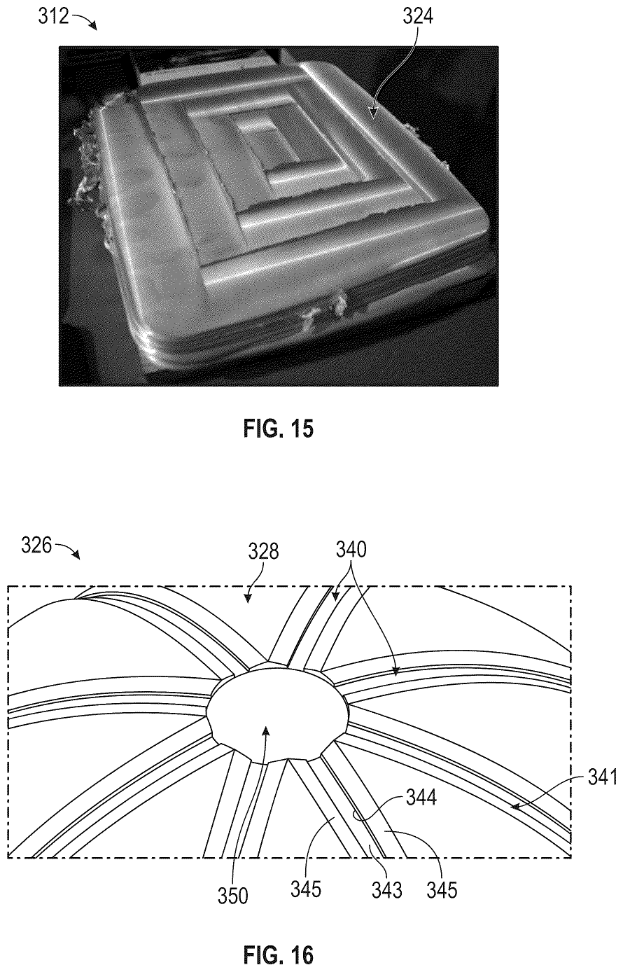

The spindle 322 can be configured to move transversely across a substrate 316 to form an initial layer of the part. The spindle 322 can then continue to move transversely across the surface of the part to form additional layers, one on top of the next. For example, the spindle 322 can be moved in the direction of the arrow in FIG. 14 while the part being formed (for example, base part 312 shown in FIG. 15) remains stationary. Alternatively, the part can be moved and the spindle 322 can remain stationary. In still another embodiment, the part and the spindle 322 can both move as layers of material are deposited. While the spindle 322 is moved across the current outer surface of the part, for example, the surface of the initial layer, the filler material currently being deposited can continue to exit the spindle 322 and be deposited to the deposition zone 318. The deposition zone 318 can include the area where the filler material exits the additive manufacturing tool 314 and/or the area where the filler material contacts the part or uppermost layer of material that was previously deposited. As the spindle 322 moves across the surface of the part, the deposition zone 318 can move to correspond to where the filler material is currently being deposited. The filler material that has exited the spindle 322 can remain at the location where it was deposited. The spindle 322 can be moved along the surface of the part a predetermined number of times to deposit a predetermined number of layers of filler material.

Any number of layers can be deposited to form the part, for example, one layer, two layers, three layers, four layers, or more. The number of layers deposited can be predetermined based on the desired characteristics of the final part. The substrate 316 can be pre-formed or additive manufactured. The substrate 316 can include the same or different material as the filler material being deposited. The substrate 316 can be removed from the part after the final part is formed or the substrate 316 can remain a portion of the final part.

The additive manufacturing tool 314 can be used to deposit filler material on a curved surface of a part. In another non-limiting example, the additive manufacturing tool 314 can be used to deposit filler material on a generally planar surface of a part, as will be described below with reference to the example embodiment of FIG. 15.

With reference to block 302 of FIG. 13, the additive manufacturing tool 314 can be used to form the initial or base part 312 shown in FIG. 15. The base part 312 can be a near net shaped part, for example, the base part 312 can resemble the intended final part. The base part 312 can be an initial part. As described herein, the additive manufacturing tool 314 can include the rotating spindle 322 having the channel 320. The channel 320 can be configured to hold the filler material, and the filler material can be deposited as layers of material to form the base part 312. The layers of filler material can transition from a softened state to a hardened state to form the base structure or the base part 312. Layers of material can be deposited one on top of each other and/or one next to each other. The number of layers deposited can be dependent on various factors, including the part thickness, the part geometry, and the intended location of embedded objects (for example, passages).

The motion of the rotating spindle 322 and the shape of the layers being deposited can be determined by the intended shape of the base part 312. According to an embodiment of the present disclosure, the base structure or base part 312 can be a heat exchanger with fins, a tank configured to hold a liquid, or a structure having a general cone or nozzle shape. The base part 312 can be an initial part that will be formed into a nozzle for a rocket engine. The rotating spindle 322 can move in the z-axis direction while simultaneously moving in circles of decreasing diameter as it deposits filler material in layers when forming a structure having the general cone or nozzle shape or a tank-shaped structure. The deposited material can be arranged in ring-shaped layers surrounding an internal cavity. The internal cavity can form a cavity of a nozzle or combustion chamber. The rotating spindle 322 can move in the z-axis direction while simultaneously moving in a square or rectangular pattern of decreasing dimensions as it deposits filler material in layers when forming a heat exchanger, such as the square shaped pattern shown in FIG. 15. The additive manufacturing tool 314 can be used to manufacture a structure of any predetermined shape can be formed by adjusting the motion of the rotating spindle 322.

The base part 312 can be formed to have a near net shape. For example, the base part 312 can be formed to closely resemble the intended final part. The motion of the rotating spindle 322 can move in a predetermined formation that is predetermined to deposit the layers of filler material in a way to closely resemble the intended final part. The formation of the base part 312 having a near net shape can eliminate unnecessary manufacturing steps.

FIG. 15 is a photograph of the base part 312. The base part 312 shown in FIG. 15 is a heat exchanger, for example a heat exchanger manufactured according to any of the embodiments described herein. However, FIG. 15 is just exemplary and any type of base part 312 or structure may be manufactured according to the present disclosure, for example nozzles for rocket engines or tanks. The base part 312 can be formed using the additive manufacturing tool 314. Alternatively, the base part 312 can be formed using any suitable manufacturing method. The base part 312 can include one or more layers. The number of layers forming the base part 312 can be dependent on the desired characteristics of the final part. For example, the number of layers can be adjusted to achieve a desired shape of the final part, a desired thickness of the final part, and a desired location of integrated parts, for example integrated passages or channels according to embodiments of the present disclosure.

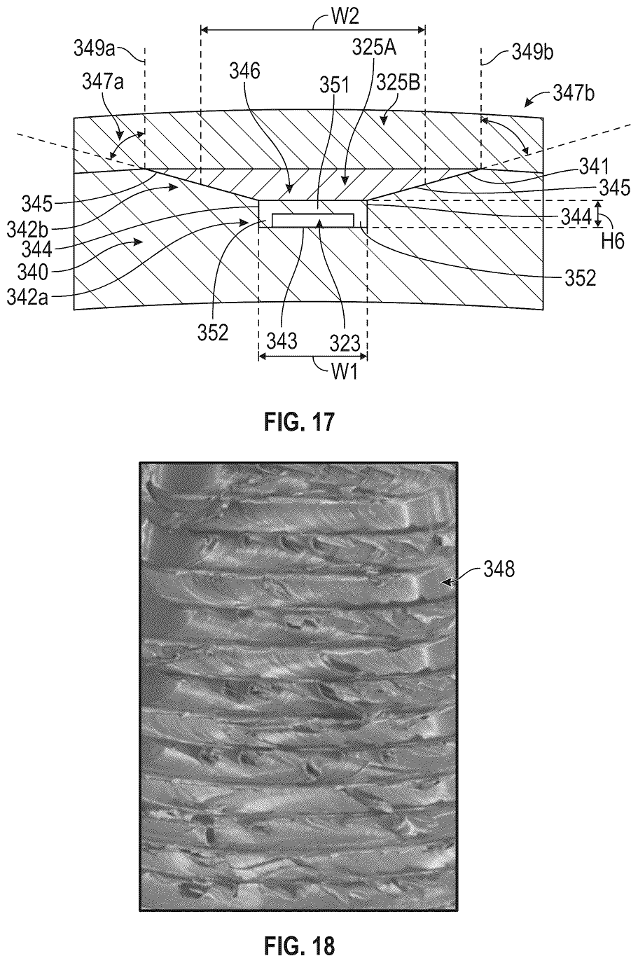

The base part 312 can have one or more passages 323, as shown in FIG. 17. The passages 323 can be disposed over a top surface 324 of the base part 312, in contact with the top surface 324 of the base part 312, and/or at least partially within the base part 312. This is discussed in more detail below with reference to FIGS. 16 and 17. The passages 323 can be disposed adjacent to each other, in a uniform pattern and/or in a non-uniform pattern. For example, the passages 323 can be positioned at different depths within the base part 312. For another example, each passage 323 can be spaced a uniform or a non-uniform distance from adjacent passages 323. Many different configurations can be suitably implemented. In one non-limiting embodiment, a first passage 323 or set of passages 323 can be positioned after a first predetermined number of layers of material is deposited by the additive manufacturing tool 314. A second passage 323 or set of passages 323 can be positioned after a second predetermined number of layers of material is deposited, the second predetermined number of layers being different than the first. The passages 323 can be formed using caps, tubing, conduits, or the like. Once positioned over and/or in contact with the surface of the base part 312, the passages 323 can be sealed or secured in place by using the additive manufacturing tool 314 to deposit one or more layers on top of and/or around the passages 323, for example, layers 325A and 325B. The layers 325A, 325B can vary in thickness or have the same thickness. The layers 325A, 325B will transition from a softened state to a hardened state over and/or around the passages 323, securing the passages 323 within the final part. Non-limiting embodiments of these processes are described in more detail below.

In some embodiments, an outer surface of the base part 312 can be machined during a first machining process to form a machined part 326 according to an embodiment of the present disclosure. The machined part 326 can generally resemble the base part 312 in size and shape. The outer surface(s) of the machined part 326 can be machined to have a generally smooth outer surface 328. In some embodiments, the inner surface(s) of the machined part 326 can be machined to have a generally smooth inner surface. FIG. 16 illustrates an example machined part 326 having a curved outer surface, for example, a curved surface of a tank. While FIG. 16 illustrates the example machined part 326, the example machined part 326 is not part 312 after machining of the outer surface of part 312. Part 312 illustrates an example heat exchanger prior to machining.

Moving to block 304 of FIG. 13, the generally smooth outer surface 328 of the machined part 326 can be machined during a second machining process to form one or more grooves or channels 340 in the generally smooth outer surface 328. As discussed above, the generally smooth outer surface 328 can be curved. In some embodiments, the generally smooth outer surface 328 can be planar or non-curved. In some embodiments, the generally smooth outer surface 328 can have portions that are planar and portions that are curved. The one or more grooves 340 can extend into the generally smooth outer surface 328 of the machined part 326. Alternatively, in some instances the one or more grooves 340 can be machined prior to the outer surface of the base part 312 being machined.

The number of grooves 340 can be dependent on the intended number of integrated passages in the final part. While 8 grooves 340 are depicted, there could be more than 8 grooves 340, less than 8 grooves 340, or 8 grooves 340. The one or more grooves 340 can be arranged in a predetermined section of the generally smooth surface 328. The one or more grooves 340 can be arranged around the entire circumference of the machined part 326. The one or more grooves 340 can extend an entire length or width of the generally smooth surface 328, or the one or more grooves 340 can have a predetermined length or width that is less than the corresponding length or width of the generally smooth surface 328. The one or more grooves 340 can extend radially outward from a central location, for example, as shown in FIG. 16. The predetermined length or width of each of a plurality of the grooves 340 can be the same or different. The one or more grooves 340 can be formed in a curved surface, a planar surface, or a surface having a combination of curved and planar features. The one or more grooves 340 can be formed in a surface that slants inward toward a central axis of the machined part 326 as the surface extends from a bottom to a top of the machined part in the z-axis direction. The distance between corresponding sections of adjacent grooves 340 can change as the grooves 340 extend along the z-axis direction. The distance between corresponding sections of adjacent grooves 340 can remain generally constant along the z-axis direction. The grooves 340 can all extend in the same general direction. The grooves 340 can be positioned generally parallel to each adjacent groove 340. The grooves 340 can extend in varying directions. Each groove 340 can have a constant depth along the groove 340 or a depth that varies along the groove 340. Each of a plurality of the grooves 340 can have the same depth but other configurations can be implanted. The grooves 340 can extend in a generally linear path but other configurations can be implanted, for example, the grooves 340 can have portions that are non-linear or turn in different directions. For example, in one non-limiting example, the groove 340 can follow a curved path. The grooves 340 can be oriented such that no two grooves 340 intersect but other configurations can be implemented.

The grooves 340 can have sidewalls 341 extending the length of the grooves 340. The sidewalls 341 can define multiple regions, for example, a first region 342a and a second region 342b of the groove 340, as shown in FIGS. 16 and 17. While two regions are depicted, there may be 1, 2, 3, 4, or more regions. The first region 342 a can be a first volume that has a rectangular cross-sectional shape. The second region 342b can be a second volume that has a trapezoidal cross-sectional shape. Portions of the second region 342b can have a greater width than the first region 342a, for example width W2 of the second region 342b. The first region 342a can be sized and shaped to receive a cap as described herein.

The first region 342a can have a base wall 343 defining a bottom surface of the groove 340. The first region 342a can have substantially parallel sidewalls 344. The sidewalls 344 can be generally perpendicular to the base wall 343. In some embodiments, the first region 342a can have a width W1 that exceeds a height H6.

The second region 342b can have tapered sidewalls 345. The tapered sidewalls 345 may be advantageous as the tapered sidewalls 245 may sustain more normal pressure as applied through the material deposition process, which can result in a stronger bond at the interface between the deposited material and the tapered side wall 345. The sidewalls 345 may be angled or tapered with one or more angles 347a, 347b that may be varied relative to a line 349a, 349 b that is generally perpendicular to the base wall 343 of the first region 342 a, as illustrated in FIGS. 16 and 17. In some embodiments, the angles 347a, 347b can be greater than or equal to 30 degrees. In some embodiments, there may be 1, 2, 3, 4 or more regions along the tapered sidewalls 345, each being tapered at a different angle 347a, 347b relative to the line 349a, 349 b generally perpendicular to the base wall 343 of the first region 342 a. The second region 342b may be configured to receive deposited material to secure caps within the grooves 340 as described herein.

Moving to block 306 of FIG. 13, a cap 346 can be positioned into a groove 340. The one or more grooves 340 can be configured to receive corresponding caps 346, as shown in FIG. 17. The caps 346 can be positioned one at a time, or a plurality of caps 346 can be positioned simultaneously. The caps 346 can be positioned manually or in an automated manner. The caps 346 may be sized such that each groove 340 receives a single cap 346 or the caps 346 may be sized such that each groove 340 receives more than one cap 346. The caps 346 can be shaped such that, when positioned into the grooves 340, the cap 346 and at least one wall of the groove 340 (for example, base wall 343) can define a passage 323, channel, or other enclosed/hollow structure. The passages 323 or channels formed by caps 346 can be configured to transport a liquid, such as but not limited to a coolant, such as but not limited to a fuel.

The caps 346 can have any suitable cross-sectional shape, for example, the cross-sectional shape of the caps 346 can generally correspond to the cross-sectional shape of one or more regions of the grooves 340 (for example, the first region 342a), or the cross-sectional shape of the caps 346 can be configured to be received within the cross-sectional shape of one or more regions of the grooves 340. In some embodiments, the cap 346 can have a U-shape. The cap 346 can have a base wall 351 and sidewalls 352. The sidewalls 352 can be generally perpendicular to the base wall 351. The base wall 351 and the sidewalls 352 can define the U-shape. The cap 346 can be positioned into the first region 342a of the groove 340 such that outer surfaces of the sidewalls 353 contact or abut sidewalls 344 of the groove 340. The passage 323 can be defined by inner surfaces of the sidewalls 352 of the cap 346, an inner surface of the base wall 351 of the cap 346, and the base wall 343 of the first region 342a of the groove 340. The sidewalls 352 of the cap 346 can have a height that is equal to, less than, or greater than the height H6 of the first region 342a of the groove 340. The base wall 351 can have a width that is equal to, less than, or greater than the width W1 of the first region 342a.

In one non-limiting embodiment of a rectangular passage 323 defined by a cap 346 and the base wall 343 of the first region 342a of a groove 340, the passage 323 has inner dimensions of about 0.08 inches by 0.2 inches and an inner cross-sectional area of about 0.016 in². In another example, the passage 323 has a circular cross-section. In one non-limiting embodiment of a circular passage 323, the passage 323 has an inner radius of about 0.07 inches and a cross-sectional area of about 0.015 in². Cross-sectional shapes and dimensions of grooves 340 can be selected such that the grooves 340 are configured to receive caps 346 having particular cross-sectional shapes and dimensions. The passage 323 can have other dimensions that can be suitably implemented in accordance with embodiments of the present disclosure.

The caps 346 can be formed of any suitable material, such as but not limited to a metal. The caps 346 can be formed of and/or include the same material of the base part 312, or the caps 346 can be formed of and/or include a material that is different than the material of the base part 312. The caps 346 can be formed of and/or include a material that is the same as or different than the material deposited to seal or secure the caps 346 in the grooves 340. The caps 346 can include a material that is stronger and/or has a higher melting point than the material being deposited over the caps 346. The caps 346 can be formed of material that can flex, bend, and/or deform as the caps 346 are positioned in the grooves 340. The caps 346 can be configured to follow the profile of the grooves 340 as they are positioned in the grooves 340, for example, the caps 346 can be configured to follow a curved profile or curved path of a groove 340.

Embodiments of the present disclosure are not limited to receiving caps in the grooves 340. In some non-limiting examples, other hollow or non-hollow structures can be received in the grooves 340, for example, tubes or wires as described in U.S. application Ser. No. 18/365079 titled “FRICTION STIR ADDITIVE MANUFACTURING FORMED PARTS AND STRUCTURES WITH INTEGRATED PASSAGES” filed on Aug. 3, 2023 and in U.S. application Ser. No. 18/365125 titled “FRICTION STIR ADDITIVE MANUFACTURING FORMED PARTS AND STRUCTURES WITH INTEGRATED PASSAGES” filed on Aug. 3, 2023, the entirety of each of which is incorporated by reference herein for all purposes and forms a part of this specification.

The passages 323 formed by the caps 346 can be integrated into a curved final part. The grooves 340 can be sized and shaped depending on the size and shape of the caps 346 that form the passages 323 in the final part. The grooves 340 can extend a predetermined depth into the machined part 326. The depth that each groove 340 extends into the outer surface 328 can be the same or different. For example, the intended positioning of the caps 346 can vary depending on the purpose and design parameters of the final part. In one non-limiting embodiment, one or more caps 346 can be positioned in a first set of grooves 340 extending into the outer surface 328 at a first depth, and one or more caps 346 can be positioned in a second set of grooves 340 extending into the outer surface 328 at a second depth different than the first depth. In some instances, all caps 346 of a plurality of caps 346 can be positioned in grooves 340 that extend into the outer surface 328 at the same depth.

The path of the grooves 340 can depend on a number of factors, for example, the shape of the machined part 326 and the intended pathway for the passages 323 formed by the caps 346. In some embodiments, the grooves 340 can follow a substantially linear path. In some instances, the grooves 340 follow a non-linear path that curves to follow a curved surface in the part 326. In addition, the cross-sectional profile of the grooves 340 can take any suitable form, including but not limited to a semi-circular, square, or rectangular cross-sectional profile. In the non-limiting embodiment illustrated in FIG. 17, the grooves 340 have a planar bottom surface (for example, base wall 343) and sidewalls 344 that are generally perpendicular to the base wall 343. The grooves 340 illustrated in FIG. 17 can be configured to receive a cap 346 with planar corresponding walls. In another non-limiting embodiment, the grooves 340 can have a semi-circular cross-sectional profile with a rounded bottom surface and curved sidewalls. Such grooves 340 can be configured to receive a cap 346 having curved sidewalls. It will be understood that grooves 340 having any suitable shape, size, and/or cross-sectional profile can be implemented in the embodiments of the present disclosure.

Moving to FIG. 18 and block 308 of FIG. 13, the caps 346 can be secured within the grooves 340. FIG. 18 illustrates layers of material deposited using additive manufacturing to secure caps 346 within grooves 340 of a machined part (for example, machined part 326) according to an embodiment of the present disclosure. Additional material 348 can be deposited over the caps 346 using a second additive process (for example, a FSAM process) according to an embodiment of the present disclosure. The additional material 348 can include one or more additional layers of material being deposited over the machined part 326 with the caps 346 positioned in the grooves 340. The additional material 348 can secure and/or seal the caps 346 at least partially within the grooves 340 when the material hardens. In some non-limiting examples, the additional material 348 being applied over the grooves 340 can fill in portions of the grooves 340 that are not filled by the caps 346 and passages formed by the caps 346, for example the second region 342b and/or portions of the first region 342a that are not sealed by the caps 346. The additional material 348 can fill the grooves 340 such that the caps 346 are secured in place in the grooves 340 and do not move within the grooves 340. The additional material 348 can be deposited on a portion of a surface of the machined part 326 or over the entire surface of the machined part 326. The number of additional layers deposited can be dependent on the intended characteristics of the final part, for example, the final part thickness, the final part geometry, and the intended location of embedded objects (for example, passages 323).

Moving to block 310 of FIG. 13, the part 326 can be machined to a predetermined final shape according to an embodiment of the present disclosure. The additional material 348 deposited over the caps 346 can be machined to a predetermined shape. The additional material 348 deposited as shown in FIG. 18 can be machined to form a generally smooth exterior surface. The thickness of the final part can be determined in part by how many layers of material were deposited during the FSAM processes, and the extent to which the base part 312 and the machined part 326 were machined during the manufacturing process. The thickness can be constant but other configurations can be implemented.

After the exterior surface of the final part has been machined to form the generally smooth surface, the part can be further processed to expose an entrance and an exit of the passages 323 which were embedded/integrated within the final part. In one example further processing step, the part may include a recessed area 350 where all passages 323 meet, thereby forming and/or exposing an entrance and an exit to each passage 323, for example as shown in FIG. 16. In some embodiments, the grooves 340 and/or passages 323 can terminate into a common channel or manifold at one or both ends of the grooves 340 and passages 323. The common channel or manifold can function as a single entrance and/or exit for a liquid. In some embodiments the grooves 340 and/or passages 323 can be connected to a chamber embedded in the part or welded to the part, for example a chamber configured to store a source of liquid or a chamber configured to receive liquid from the passages 323.

### Implementation Details

While the above detailed description has shown, described, and pointed out features of the present disclosure as applied to various embodiments, it will be understood that various omissions, substitutions, and changes in the form and details of the device or process illustrated may be made by those skilled in the art without departing from the spirit of the present disclosure. As will be recognized, the present disclosure may be embodied within a form that does not provide all of the features and benefits set forth herein, as some features may be used or practiced separately from others. All changes which come within the meaning and range of equivalency of the claims are to be embraced within their scope.

The term “comprising” as used herein is synonymous with “including,” “containing,” or “characterized by,” and is inclusive or open-ended and does not exclude additional, unrecited elements or method steps. With respect to the use of substantially any plural and/or singular terms herein, those having skill in the art may translate from the plural to the singular and/or from the singular to the plural as is appropriate to the context and/or application. The various singular/plural permutations may be expressly set forth herein for sake of clarity.

It will be understood by those within the art that, in general, terms used herein are generally intended as “open” terms (for example, the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to embodiments containing only one such recitation, even when the same claim includes the introductory phrases “one or more” or “at least one” and indefinite articles such as “a” or “an” (for example, “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (for example, the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (for example, “a system having at least one of A, B, and C” would include but not be limited to systems that have A alone, B alone, C alone, A and B together, A and C together, B and C together, and/or A, B, and C together, etc.). In those instances where a convention analogous to “at least one of A, B, or C, etc.” is used, in general such a construction is intended in the sense one having skill in the art would understand the convention (for example, “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

The above description discloses several devices, methods, and materials of the present disclosure. The present disclosure is susceptible to modifications in the devices, methods, and materials, as well as alterations in the fabrication methods and equipment. Such modifications will become apparent to those skilled in the art from consideration of this disclosure. Consequently, it is not intended that the present disclosure be limited to the specific embodiments disclosed herein, but that it covers all modifications and alternatives coming within the true scope and spirit of the present disclosure.

What is claimed is:

1. A method of additively manufacturing a part having fins, the method comprising:
positioning a first spacer between a first fin and a second fin, each fin having a first side and a second side, the first spacer positioned between the first side of the first fin and the second side of the second fin;
depositing at least one layer of material to join the first fin and the second fin; and
removing the first spacer from between the first fin and the second fin.

2. The method of claim 1, wherein the part is a heat exchanger.

3. The method of claim 1, further comprising positioning a second spacer between the first side of the first fin and the second side of the second fin, wherein the second spacer abuts a surface of the first spacer.

4. The method of claim 3, wherein depositing the at least one layer of material joins the second spacer to the first fin and the second fin.

5. The method of claim 3, wherein the second spacer and at least one of the first fin and the second fin comprise the same material.

6. The method of claim 1, wherein the first spacer comprises a material different than a material of the first fin and a material of the second fin.

7. The method of claim 1, further comprising drilling a plurality of passages in the at least one layer of material.

8. The method of claim 1, further comprising machining the at least one layer of material.

9. The method of claim 1, wherein a length of the first spacer is less than a length of the first fin and a length of the second fin.

10. A heat exchanger comprising:
a plurality of fins, each fin having a first end and a second end, adjacent fins of the plurality of fins spaced a distance apart, the distance apart defined at least in part by at least one spacer positioned between adjacent fins during a manufacturing process; and
a plurality of layers of deposited material joining the first ends of the plurality of fins.

11. The heat exchanger of claim 10, further comprising a plurality of passages drilled in one or more of the plurality of layers.

12. The heat exchanger of claim 10, further comprising a plurality of spacers, each spacer positioned between adjacent fins and joined with at least one layer of the plurality of layers of deposited material.

13. The heat exchanger of claim 10, further comprising a plurality of passages machined in one or more of the plurality of layers.

14. A structure produced by an additive manufacturing process, the process comprising:
positioning a first spacer between a first fin and a second fin, a material of the
first spacer being different than a material of the first fin and the second fin;
depositing at least one layer of material to join the first fin and the second fin;
removing the first spacer from between the first fin and the second fin; and
machining a portion of the structure.

15. The structure of claim 14, wherein the structure is a heat exchanger.

16. The structure of claim 14, wherein machining the portion of the structure comprises drilling passages through the at least one layer of material.

17. The structure of claim 14, wherein machining the portion of the structure comprises machining a surface of the at least one layer.

18. The structure of claim 14, wherein the process further comprises positioning a second spacer between the first fin and the second fin, wherein the second spacer abuts a surface of the first spacer.

19. The structure of claim 18, wherein depositing the at least one layer of material joins the second spacer to the first fin and the second fin.

20. The structure of claim 18, wherein the second spacer and at least one of the first fin and the second fin comprise the same material.
